(19) United States
(12) Patent Application Publication
(10) Pub. No.: US 2005/0139414 A1
(43) Pub. Date: Jun. 30, 2005

(54) Gyrating acoustical bearing brackets

(76) Inventor: Nicholas Edwin, Tampa, FL (US)

Correspondence Address: Nicholas Edwin, 3911 North Dartmouth Avenue, Tampa, FL, 33603, US

(21) Appl. No.: 10/748,414

(22) Filed: Dec. 30, 2003

(51) Int. Cl. G10K 13/00; H04R 7/00

(52) U.S. Cl. 181/171

(57) ABSTRACT

The “Gyrating acoustical bearing brackets” is made up of two major components, a bearing ring mount and a speaker unit. The bearing mounts are currently being used in the industry today in mechanical devices, which require a cylindrical rod to be rotated while being supported usually in between its high stress areas generated by torque. The bearing mount then allows the rod to rotate freely while being supported along its high stress areas. Currently the speaker unit is widely used in the industry today in home and audio devices to produce sound generated my electromagnetic pulses entering its coils and magnets. The two devices are currently not associated, due to each having a separate function in aspects of mechanics and the other in electronics. The “Gyrating acoustical bearing brackets” combines the two separated field elements into a single apparatus.

A bracket lying on a bearing is shown, for providing audio sound through a wave replicating device or module, which gyrates when power is applied to speaker. An audio transcender is mounted on a face similar to a bearing device, which then can be installed and or placed on any open or closed enclosure. These rotating brackets provide any speaker like device to produce acoustical sounds then being gyrated on its axis. The bracket then suspends the speaker and allows pre-bracket performance to occur. The bearings mounts consist of two structures. The outer bracket structure, which houses the combined device to any existing to proposed enclosure and the Inner structure which assemblies via cylindrical bearings and or ball bearing to the outer bracket structure. The two circular structures combined, allows any attached speaker or audio producing device to spin and/or gyrate in a variation of or equal to three hundred sixty degrees rotations. The finally is unison of the two structures as one that provides rotation. The effect is to allow a gyrating conductor within the fastened receptacle similar to brackets to perform.

### BACKGROUND OF THE INVENTION

Since the first speaker invention, innovative designs have been made to maximize sound reproduction. In 1920's, Chester W. Rice and Edward Washburn patentee the prominent design for speakers which incorporated the moving coil and direct radiator. The speakers were sold to the public by the name of “Radiola”. Within its period of time, its sound reproduced was superior to anything previously invented. The unique design lessens distortion and enhanced audio quality.

Other exemplary designs have been made to Subwoofer, Woofers, tweeters, and midrange speakers. Better cooling designs, improved magnets, higher wattage handling, and stronger more rigid materials. All these combinational and exploits in the filed have enable higher fidelity audio reproduction and listening pleasures.

Another integral part of this design is ball bearings. Many dramatic advances have been accomplished throughout history on the ball bearing. Different ball bearings have been designed to accomplish many different tasks. Weight, RPM, and lubrication, have all been so precisely engineered to accomplish any giving task needed.

The Ball bearing too has evolved. Then in 1844 the invention of the BALL-BEARING wheels made these two contraptions glide easier causing little to no friction. Since Sven Wingquist created the self-aligning ball bearing in 1907, worldwide, new developments in use, and various applications can be employed. In the early 1700's, a Dutchman nailed wooded spools to strips of wood and attached them to his shoes. Later in 1863, James Plimpton added maneuverability to the innovation and updated the land skates.

The “Gyrating Acoustical Ball Bearing” as described uses a combination of modern innovations to achieve and optimize its use. The method used to achieve this rotation is bearing brackets. These brackets that can be applied to any existing speaker device. These brackets, since they contain bearings, both cylindrical or ball bearing, or a combination of therefore can provide a frictionless environment for the speaker to gyrate while being played or in a rest state position, on its or axis or bracket ring. The existing device will have quick setups and a complete compatibility on any acoustic suspension systems or bass reflex speaker systems. Any of these enclosures will not interrupt with its intent. Thus the gyrating speaker apparatus ads free movement but non-interference with calculated specs designed for a system. The resulting structure provides a higher efficiency in movement but not depreciation in quality caused by an steady bracing of the speaker.

In this case the brackets can essentially provide aesthetics as well as efficiency due to it gyrating waveforms produce enhancing vocal ambiance and a multi directional flow of acoustics an every given degree. Agitation by more power being added to the speaker system will aid in Its 360-degree self-rotation. Thus cresting more rapid rotation using kinetic energy generated by the speaker. This device can especially be used in smaller environments (ex. Automotive) where a multi-timbrel effect as well as aesthetically pleasing facial is needed in a limited space.

U.S. Pat. No. 6,374,942 to Huggins, a patent that provides a system for a combined rotable and electrical speaker mounting system. This system allows the positioning and re-positioning of a speaker system with full rotational motion of the speaker to direct aim without severing the electrical connection. Huggins speaker assembly is configured for a speaker that suffers from directionality and sound distance attenuation limitations. Huggins speaker assembly is configured with a mechanical mounting mechanism and configured to establish an electrical connection between the speaker and the enclosure. Although Huggins speaker system allows rotation, its rotation is based on fixture like enclosure that is manually rotated and locked to better disburses sounds (in home audio systems) downward. His invention also consists of a cylindrical members that is configured to axially concentrically couple with one another, which allows the speaker to have a full range of motion (i.e. when adjusted by user) with respect to the enclosure to be adjusted without using tools to disassemble and rewire the system. But this system is complex and cannot be adapted quickly into an existing car audio speaker system, especially with off the shelf components. His speaker apparatus also allows for full directional aiming of the speaker due to the electrical connections and the mechanical connections being independent.

Thus the “GYRATING ACOUSTICAL BEARING BRACKETS” device is neither an aiming apparatus nor a speaker recesses in and/or fixture like, lighting enclosure system. Nor thus this device incorporates any electrical connections to the proposed enclosure/speaker. Thus not needing independent mechanical and electrical members. Thus the “Gyrating Acoustical Bearing Bracket” uses ring strips that mount to the underside of a speaker, to allow impulse driven sporadic movements. Therefore the industry needs a quick, simple, thin, rigid add-on bracket that can be installed on any existing and/or pre-developed system, which uses bearings brackets to house a combination of one or more speaker units. When agitation is generated by kinetic energy from the speaker vibrations, a gyration or a swinging like motion performance occurs on its axis, due to powered being exerted through stereo system and/or amplifiers. The more power output by stereo/amplification system, into the speaker placed inside the bearing brackets, the more gyrations increase in angular degrees.

### SUMMARY OF THE INVENTION

Disclosed is a device composed of bearings rings designed to mount between an acoustical sound speaker and an enclosure or structure, allowing it to use kinetic energy to gyrate freely. Designed for a stereo purpose as an add-on unit or pre-installed setup. Each bracket can accommodate one or more speakers depending on interior diameter (I.D.—see drawing I) size and speaker exterior diameter (E.D.—see drawing I) size. Each bracket can be used solely in part as a muti-setup display or a combination of multiple setups and adjoining configurations.

An ideal installation is preferred where the brackets are placed in an enclosure adapted and configure for that particular speaker system. Where in volume sizes, port sizes, recessed and or channelized designs, have already been pre-configured.

The gyrating bracket shape helps in becoming well suited to almost any exiting speaker container. The Interior Diameter (I.D.—see drawings I) being the size of most standard sized speaker system makes it very compatible. The exterior diameter a little bigger than the interior diameter (I.D.—see drawings I) allows firm bracketing to enclosure allowing adequate suspension for excess load excessively moving and vibrating speaker.

The gyrating brackets further provide enhanced speaker functionality effect that prior or typical rigid adaptation did not provide. This is accomplished by allowing the speaker to gyrate on it's own reconnaissance. Free gyrating functionality disallows any suppression encompassed by rigid brackets therefore improving acoustic presence. The unveil apparatus is an performing acoustic replicator of any design bracketed within the circular ring having an interior diameter (I.D.—see drawing I) of the same or smaller inner bracket, facing away at one end and which then is secured inside another circular ring separated by bearings, which is then bracketed on a cabinet enclosure via any fastening device. The inner circular ring bears another opening, which is used to house a speaker unit(s). This opening typically resembles a circular from, but can be configured to any shape or form to co-exist on any irregular manufactured speaker system. The exterior surface of the inner circular ring contains a notch running parallel to the face of the ring or circumscribed along its outer diameter. This notch bears a bearing, which allows a channelized path for the bearing to glide around its perimeter. Another notch is placed on the surface of the outer circular ring running parallel to the perimeter of the ring or inscribed along its inner diameter. Again this notch allows free play between outer interior bracket and the exterior bracket. The outer circular ring, brackets to a cabinet (or any variation) enclosure via any fastening device. When completely installed the structure provides the speaker with self-inflicting gyrating swings in its axis, when the speaker is in use. More variable rotations may be achieved by applying more power to system via amplifier or stereo outputs/inputs.

The objection of this information is to reveal an attachable bearing slip apparatus, which can be used on all pre-existing speaker systems but can be configured into new modules, to reproduce an unmanned variable rotational effect. Therefore already using provided or thus to be provided power consumption for acoustical device.

An additional objection of this device is to enhance aesthetics and visual looks due to its life like dance motions, which occurs on a rhythmic manner as music is played.

Another objection in this development is its ease to install and its compatibility to all existing systems. Any existing systems speaker cabinets (enclosures) can be fitted to adapt to this brackets. And converted to a self-spinning acoustical system.

Another distinction in these brackets is to develop in uncomplicated systems that maximize a low frictional apparatus to execute known gravitational variables. Thus foremost solely rely on stereo outputs/inputs and environmental gravitational changes to gyrate the speaker unit.

Manufacturing is simple due to its simple, and well used (in other applications) bearing brackets as one of its comprised components, which makes it a inexpensive add on device.

These described devices, components, and objects will be detailed in a FIG. 1-8 and more description as well as explanation will be discussed about the drawing.

### BRIEF DESCRIPTION OF THE DRAWINGS

FIG. 1 shows the front view of the bearing bracket of the invention.

FIG. 2 shows a cross section view of FIG. 1 of the above mention invention.

FIG. 3 shows a zoom in (close-up) view of FIG. 1 encompassing a shaded surface representation.

FIG. 4 shows a zoom in (close-up) view of FIG. 1 encompassing all hidden elements that can be seen from the rear view displayed from the front view of a surface scan.

FIG. 5 shows an isometric representation of the speaker module to be encompassed in bearing bracket.

FIG. 6 shows an isometric representation the bearing bracket apparatus that houses the speaker and mounts to the enclosure.

FIG. 7 shows an isometric representation of a zoom in (close-up) view of FIG. 6 detailing the bearing and bracket configuration.

FIG. 8 shows an isometric representation of both the speaker and bearing brackets assemblies with exception of enclosure.

### DETAILED DESCRIPTION OF THE MENTIONED FIGURES

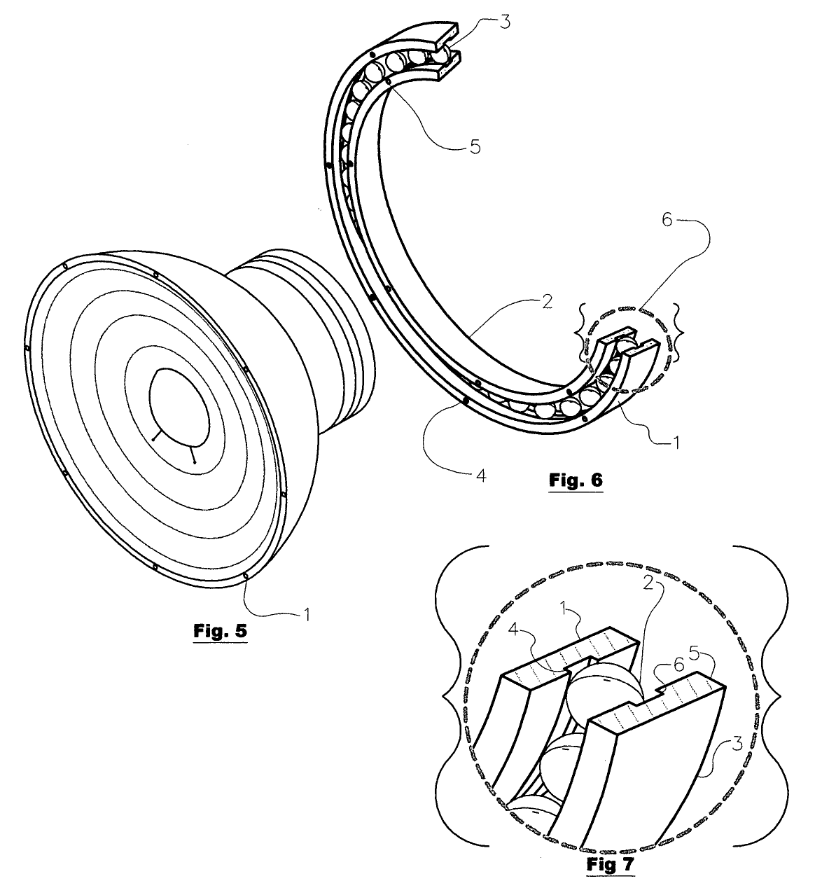

FIG. 1 shows the assembly of a bracket by means of the two circular rings surrounded by bearings, less the speaker adaptation containing the outer circular ring 1, and the inner circular ring 2. The outer circular ring 1 has screw hole 3 that goes through the body allowing firm installation on to the enclosure. The inner circular ring 2 also has the has screw hole 4 that goes through the body allowing firm installation of the speaker device FIG. 5 to mount securely. This is made possible by the opening in 5 that is placed within the inner ring 2. This opening in this figure is of the form of a circular diameter but can be any irregular or polygonal shape needed to encompass the acoustic replicator.

An alternate configuration can be achieved but not shown where the ring 1 can also be mounted behind ring 2, mirroring the entire internal assembly from an interior configuration to a rear arrangement. This would imply that the channelized pathway that is currently shown on FIG. 7 callout (4,6) would now be shifted to back of bracket shown in FIG. 7 callout (5). Also ball bearing FIG. 7 callout (2) and interior ring FIG. 7 callout (1) would be placed to back of outer bracket FIG. 7 callout (5).

It is not necessary in the design of the invention that the hole 5 within the inner ring or the speaker be round, nor is it necessary that the inner circle of the inner ring house one speaker. Thus an alternate version is theoretically possible in which more than one speaker can be used in the internal ring as a multiple speaker combination or multiple speaker sizes.

FIG. 2 shows the cross sectional view of the assembly of the two rings by means of the two circular rings with bearing less speaker adaptation, the outer cross sectional view or exterior diameter (E. D.) can be clearly seen 1 on top of the interior ring (I.D.) 2. They are separated by bearings 5 arranged in chanelized crevasses FIG. 4 callouts (2,3). The diameter of the outer ring 1 is calculated after the inner ring 2 is known. The inner ring 6 is calculated after the speaker size is anticipated allowing plus (+) inches for the mounting screws and nuts. The bracket width 3 is calculated after knowing the devices wattage and power handling capacity. A one-inch width will over accommodate an average subwoofer system, but will need adjustment to accommodate different handling loads.

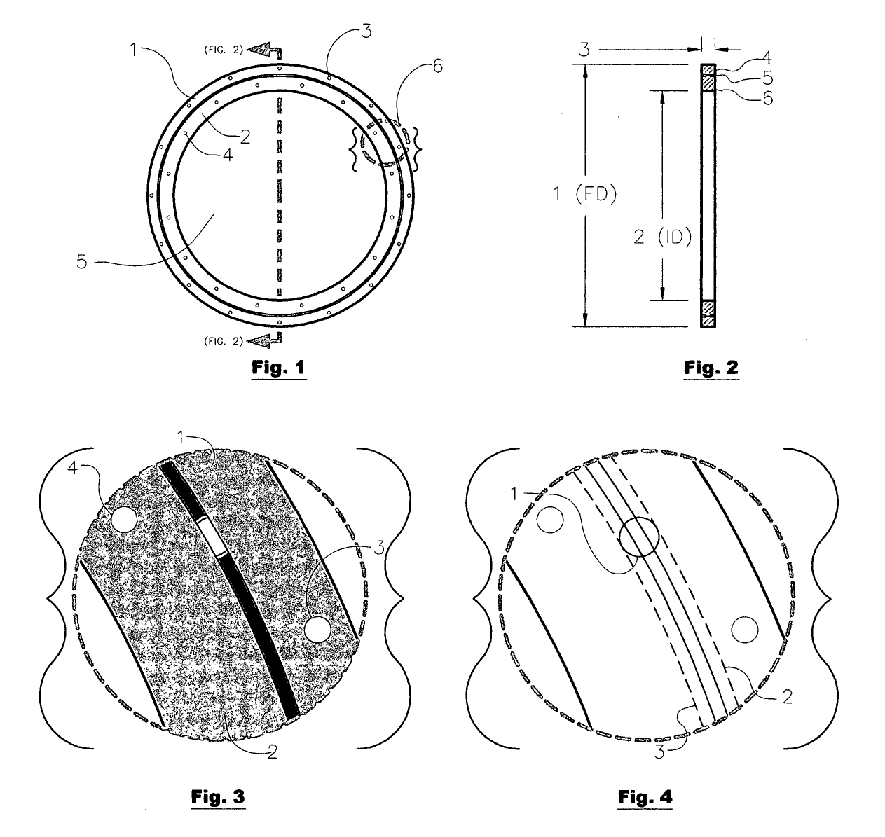

FIG. 3 shows a surface view zoom in section of FIG. 1 callout (6). This zoom in area shows the outer circular ring 1 and the inner circular ring 2. The outer circular ring 1 has screw hole 3 that goes through the body allowing firm installation on enclosure. The inner circular ring 2 also has the screw hole 4 that goes through the body allowing firm installation of the speaker device FIG. 5.

FIG. 4 shows a hidden surface view zoom in section of FIG. 1 callout (6). This zoom in area shows the hidden channelized guides that align the bearings 1 between the inner channel 3 and the outer channel 2, providing a smooth friction less movement between the two entities.

Bearing 1 size will directly relate to weight of speaker unit and system vibration foreseen that the outputs will reproduced. Total speaker wattage and load capacity will dictate a stretching of exterior diameter FIG. 2 callout (1), along with channelized areas 2,3 to increasing and accommodate larger more robust bearings 1.

Bearing 1 quantity can be increased to also aid in the structural support and integrity needed to bind components securely.

Bearing 1 type can also be modified into various type different bearings or a combination of thereof. Cylindrical bearings can be used. Angular bearings can be used, metal, plastic, synthetic, bearings can also be used. Any type or variation plus combination thereof can be substituted or implemented in this design. Metal ball bearings, Plastic ball bearings, linear ball bearings, needle roller bearings, thrust bearings, Pressed bearings, Y-Bearings, Angular ball bearings, CARB toroidal roller bearings, Spherical roller bearings, Taper roller bearings, etc.

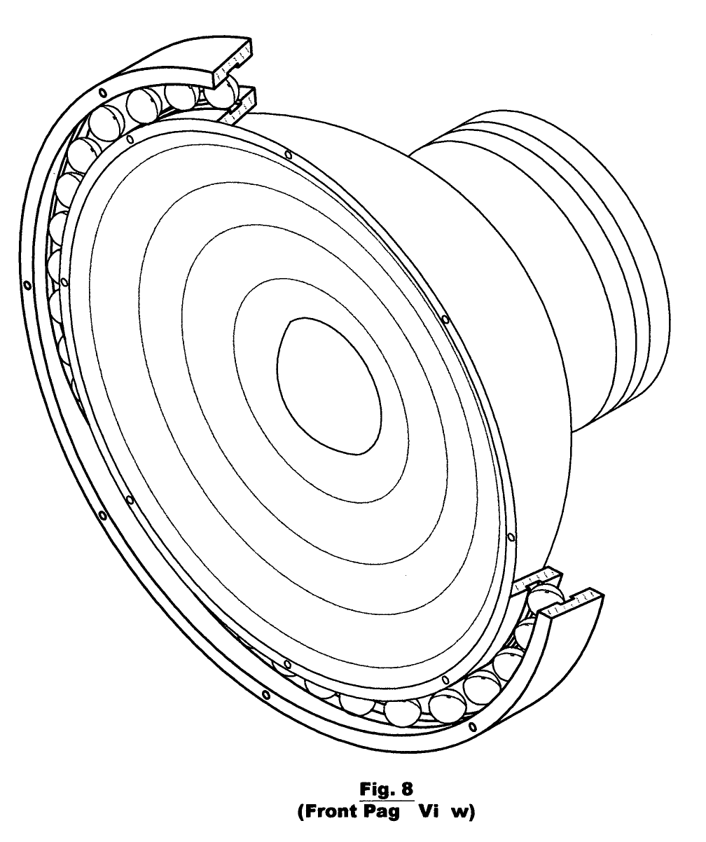

FIG. 5 depicts an acoustical replicator, aka speaker module with various hole's 1 around the outer perimeter of the speaker. These allow firm bracketing on the interior bracket FIG. 6 callout (2) via nut and bolt assembly.

Speaker adaptation can vary from circle diameter modules, rectangular modules, triangular modules, and polygonal modules.

Speaker types can me retrofitted, form subwoofer assemblies to woofer assemblies, and or any other speaker console therefore.

Turning to FIG. 6, showing a complete bracket assembly comprised of all entities less speaker FIG. 5. The internal ring 2 preferably a plastic or synthetic material, but can be modified per custom specification, which houses the speaker unit FIG. 5. Speaker unit fits on front plane of said internal ring. Internal ring bears holes 5 that align with speaker holes FIG. 5 callout 1. With these aligned a nut and bolt assembly, which is not shown, can be accepted from face plane of speaker FIG. 5 through internal ring 5. The nut and bolt assembly, which is not shown, will slip through holes FIG. 5 callout (1) and enter holes on inner ring 5. The nut will attach to bolt on the rear plane for ridged and firm placement on inner ring 2 front plane. After speaker unit FIG. 5 is in place inner ring it is surrounded by bearings 3. Bearings set primed in channelized notches FIG. 7 callout (4,6) along the outer perimeter of inner ring 2. Bearings 3 then fit along another channelized path along inner perimeter of outer ring 1. Outer ring 1 preferably a plastic or synthetic material but can be modified per custom specification, these houses are utilized to allow interior speaker to free flow on its own kinetic energy generated by sound input /output. By outer ring 1 being firmly mounted with nut and bolt assembly or screw type attachment which is not shown will slip through said hole's FIG. 5 on enclosure through holes 4 going through embodiment. Interior ring 2 and speaker unit FIG. 5 can sustain suspension by exploiting bearings 3 after being harbored in channelized notch for support. Making interior ring 2 operate on variable gyrating axis when power is applied to speaker.

FIG. 7 thus shows a zoom in area of FIG. 6 callout (6) to better described channelized interaction. Interior ring 1 is shown with channelized notch 4 where bearing 2 sits in a confined compartment. Beneath this arrangement lays outer ring 3, which also have a channelized notch 6, which then confines bearings 2 to stay aligned, and allows inner ring 1 to free flow.

Zoom in depiction allows a clearer view of how interaction will work for projected performance. But individual components can be rearranged to work in a like manner. Channelized notches FIG. 7 callouts (4,6) can be reverted to different planes. For example channelized notches can be reverted to rear plane 5 and all other components follow in like manner. From Inner ring 1 being converted to front ring, channelized notch 4 being converted to channelized ring on the rear plane 5, bearings 2 being converted to bearing on rear plane 5, outer ring 3 being converted to rear ring on rear plane 5, as well as channelized ring 6 being converted to channelized ring on rear plane 5.

FIG. 8 shows depiction of all component co-existing less enclosure environment. Image shows a complete bracket assembly comprised of all entities with speaker FIG. 5. The internal ring FIG. 6 callout (2) that houses the speaker unit FIG. 5. Speaker unit fits on front plane of said internal ring. Internal ring bears holes FIG. 6 callout (5) that aligns with speaker holes FIG. 5 callout (1). With these alignments a nut and bolt assembly can be accepted from face plane of speaker FIG. 5 callout (1) through internal bracket FIG. 6 callout (5). The nut and bolt assembly, which is not shown, will slip through said holes FIG. 5 callout (1) and enter holes on inner ring FIG. 6 callout (5). The nut, which is not shown, will attach to bolt on the rear plane for ridged and firm placement on inner ring FIG. 6 callout (2) front plane. After speaker unit FIG. 5 is in place inner brackets is surrounded by bearings FIG. 6 callout (3). Bearings sit primed in channelized notches FIG. 7 callout (4,6) along the outer perimeter of inner ring FIG. 7 callout (1). Bearings FIG. 6 callout (3) then fits along another channelized path along inner perimeter of outer ring FIG. 7 callout (3). Inner ring FIG. 6 callout (2) housing is utilized to allow interior speaker to free flow on its own kinetic energy generated by sound input/output. By the inner bracket FIG. 6 callout (2) being firmly mounted with nut and bolt assembly which is not shown or screw type which is not shown or attachment which is not shown will slip through said hole's FIG. 5 callout (1) on enclosure through holes FIG. 6 callout (5) going through embodiment. Interior bracket FIG. 6 callout (2) and speaker unit FIG. 5 can sustain suspension exploiting bearings FIG. 6 callout (3) being harbored in channelized notch for support. Making interior ring FIG. 6 callout (2) operate on variable gyrating axis when power is applied to speaker.

“Less enclosure” means less embodiment close or open synthetic or wooded housing. Per detail description above, much emphasis was not made on enclosure type, size or shape. Since the gyrating bracket is made as an add-on supplemental kit. Mention to enclosure type has no impact. Meaning bracket can be added on to any existing or new enclosures to achieve kinetic movements form the speaker when amplification or typical stereo system applies power.

Environment was also not taken into account due to bracket being an add-on supplemental kit. Meaning enclosure calculations is not needed on pre-existing speaker to enclosure systems. And after already calculated enclosure specs on new systems have been calculated then adaptation installation can begin.

Kinetic energy has been stated meaning power or force exerted to speaker system thus allows speaker, woofer, sub-woofer, or any acoustical replicator to vibrate. Vibration then allows unit to spin or be agitated in a life like form when music is played being that bearings allows speaker to move.

Acoustical replicator has been generated throughout patent describes, and specifications. Acoustical replicator generally means speaker unit, or any speaker unit that generates audio sounds via electronic signals processed and reproduces as known as sound.

While this invention has been described expressively above. With said attachments and configurations, it is to be unwritten that the invention is not limited to the exact descript, but is anticipated to cover assorted modifications, variations and or similar concepts within the span of the appended claims.

1. An attachable bearing bracket inserted into any open or closed enclosure, allowing a sound replicator and or speaker to gyrate freely around its circumference/inner perimeter that consist of:
An outer circular ring having a channelized spherical notch;
Ball bearings that reside in the said notch;
An inner circular ring having a notch that resided inscribed in the circle to said outer ring;
Ball bearing placed between said outer and inner rings;
Spherical balls provide a friction free environment for gyrating said inner ring;
The combination of said inner and outer circular rings comprise into functional bracket;

2. Apparatus as described in claim one above further comprising:
Said acoustical replicator defines a top face or front of said bracket;
Said front or top face brackets adjoins said inner circular ring;
An acoustical replicator fastens in said inner circular gyrating ring;

3. The mechanism as described in claim two above encompasses the adding of mounts on a pre-existing or proposed design application.

4. The device as described in claim one above wherein said outer circular ring and said ball bearings and said inner circular ring and with but not obligatory said acoustical replicator, have a gyrating disposition on any gyrating degrees.

5. The mechanism as described in claim one above provided unregulated variable rotations on its axis from its environment.

6. The combinational effort reproduced, allows sound waves to gyrate sporadically outwards towards its destine.

7. The combinational effort reproduced, allows sound waves to gyrate sporadically outwards towards its kinetic energy.

8. The bracketed said sound replicator can thus be gyrated more rapidly through kinetic energy absorbed through enclosure.

9. Said unregulated variable rotations disposes said waves to enhance sound effects.
